(19) United States
(12) Patent Application Publication
(10) Pub. No.: US 2002/0189119 A1
(43) Pub. Date: Dec. 19, 2002

(54) Precision alignment and marking device

(76) Inventor: Richard C. High, Broomfield, CO (US)

Correspondence Address: JAMES R. YOUNG, 11184 N. HURON ST., SUITE 15B, DENVER, CO, 80234, US

(21) Appl. No.: 09/884,299

(22) Filed: Jun. 19, 2001

(51) Int. Cl. G01D 21/00

(52) U.S. Cl. 33/613

(57) ABSTRACT

A device used to mark mounting hole locations for hanging devices on a wall or other surface. The device has a rail with calibration marks printed or scribed thereon, and two movable marking brackets, each of which contains a marking or scribing element, in the form of a protrusion or center punch located on the back of the marking bracket. Also mounted to the rail is a movable leveling bracket which contains both horizontal and vertical levels. The marking brackets are set to a desired separation distance and the device is placed against the wall. The device is aligned using the levels, and then the device is pressed against the surface to cause the marking elements to create marks or indentations in the wall where the mounting holes are to be located.

### TECHNICAL FIELD

This invention relates to alignment devices for mounting objects on a vertical surface and more particularly to devices and methods for leveling and aligning an object as it is mounted.

### BACKGROUND OF THE INVENTION

Practically everyone has experienced the difficulty in hanging a shelf, cabinet, bracket, photograph, picture, mirror, or other object at a particular location on a wall. The most difficult task while mounting objects on a wall is to accurately mark the location for the mounting devices, or the location for mounting holes. When multiple objects are being hung, it is difficult to achieve correct horizontal and vertical spacing of the mounting holes, particularly if only person is performing the task. When mounting shelving using L-shaped brackets, for example, one must align the brackets so that the shelf is level, but one must also align the brackets so that the portion of the L-bracket attached to the wall is vertically aligned, so that the shelf sits level on the bracket.

As another example, pictures can be hung by various techniques, but one of the most common techniques is to extend a wire across the backside of the picture frame. This wire will extend outwardly from the back of the picture frame so as to engage hanging devices, such as a pair of nails, pegs, hooks or the like, affixed to the wall. It is often quite difficult to accurately place the hanging devices on the wall, and in particular it is difficult to achieve proper horizontal separation and alignment of the hanging devices. This alignment is often attempted by simply measuring relevant distances between the floor and ceiling in the room intended for hanging the picture, however, it is difficult to make these measurements while at the same time marking the location for the hanging devices. Also, if the corners of the wall are not straight, as is often the case, the measurements will be inaccurate.

A mason's level, such as that used by construction workers, is only of limited assistance since it is often very difficult to hold the level horizontally without the aid of another person while hammering or screwing the hanging devices into place. Further, the application of penciled lines, or the like, on clean walls is neither desirable nor aesthetically acceptable. These markings often cannot be removed at a later time and if such markings are made with colored markers they will eventually shine through and remain visible even after being painted over.

One prior art device for hanging pictures is U.S. Pat. No. 4,241,510 entitled “Aid For Hanging Pictures” issued Dec. 30, 1980 to Radecki. This device is of an inverted “T” shape having cross arms and a neck part. It includes a horizontal rail having calibrated markings thereon and a vertical rail also having calibrated markings thereon. It includes levels on both the vertical and horizontal members and further includes movable elements for hanging the wire of a picture frame onto these elements. One deficiency of this device, however, is that the device does not include a means for marking the surface on which the picture is to be hung, and thus the marking must be done with a separate device such as a pencil as illustrated in FIG. 4 of the patent.

U.S. Pat. No. 6,029,362 entitled “Alignment Device” issued Feb. 29, 2000 to Miodragovic includes a horizontal rail with a movable leveling device attached thereto. This device further includes a hinge member for allowing placement on outside corners of walls.

U.S. Pat. No. 4,473,957 entitled “Device For Locating a Frame Hanger” issued Oct. 2, 1984 to Faulkner shows a device for hanging a single nail or pin upon a wall and includes an element for marking the location on the wall. However, the marking element must be separately activated by a person's hand, thus if two of these devices were attempted to be used to locate two nails on a wall it would require a second person to have enough hands to activate the marking element.

A German patent, DE2750716, entitled “Combined Spirit Level and Marking Gauge” published Nov. 12, 1977 by Sorgel shows a horizontal rail having a pair of marking pins. After placing the device in position, the marking pins are used to mark the horizontal surface by striking the pins with another device, such as a hammer. This device also suffers from the limitation of requiring a second person, one to hold the device level and a second to strike the marking devices with the hammer.

Thus, there is need in the art for a device that will allow the marking of locations for two different nails, pins, or the like upon a vertical surface. There is further need in the art for such a device that will allow the pins to be located level on the surface and further allow the device to be used by a single person. The present invention meets these and other needs in the art.

### SUMMARY OF THE INVENTION

It is an aspect of the present invention to mark locations for mounting an object, using hanging devices or mounting holes, on a vertical surface such as a wall.

It is another aspect of the invention to align the locations to be marked with calibration marks along a ruled support member or rail.

Another aspect of the invention is to level the rail before marking the locations of the hanging devices or mounting holes.

Still another aspect of the invention is to allow marking of several spaced apart locations on the wall by pivoting the device about one marking location or by pivoting the device about each successive marking location.

A further aspect of the invention to mark the locations a predetermined distance from a corner of an adjacent wall.

A still further aspect of the invention is to provide extendable rails so that the hanging devices or mounting holes can be marked at extended distances from a corner of an adjacent wall or from another object already mounted on the wall.

The above and other aspects of the invention are accomplished in a Precision Alignment and Marking Device having a rail with calibration marks printed or scribed thereon. Attached to the rail are two movable marking brackets, each of which contains a marking or scribing element, in the form of a protrusion or center punch or the like, on the back of the mounting bracket. The mounting brackets are moved to a location on the rail and aligned with one of the calibration marks, and then temporarily locked into place using thumb screws or the like. The location for the mounting brackets is determined by the location and separation desired for the mounting holes on the wall.

Also located on the rail is a movable leveling bracket which contains both horizontal and vertical levels. This bracket is also temporarily moved to a point on the rail where it can easily be viewed and locked using a thumb screw. Typically the leveling bracket will be placed to achieve the most accurate leveling of the rail by moving it to a location that allows it to be easily viewed from a location perpendicular to the level being used.

The device is then placed against the wall on which the object is being mounted. Optionally, when the object is being placed at a desired distance from a corner of the wall or from another object already mounted on the wall, one end of the rail is abutted to that corner or to an edge of the other object. The levels are then used to align the rail, either horizontally or vertically depending upon the mounting orientation, and then the device is pressed hard against the wall to cause the marking element on the back of the marking brackets to make marks or indentations in the wall where the hanging devices or mounting holes are to be located.

The device is then removed and the hanging devices or mounting holes placed in the wall at the locations set by the marking elements.

### DESCRIPTION OF THE DRAWINGS

The above and other aspects, features, and advantages of the invention will be better understood by reading the following more particular description of the invention, presented in conjunction with the following drawings, wherein:

FIG. 1 shows the device of the present invention with the rail or ruled support member, a front view of the marking bracket hole locators and a front view of the leveling bracket;

FIGS. 2A and 2B show a detailed drawing of the marking bracket, wherein FIG. 2A depicts a side view and FIG. 2B depicts a rear view of the bracket;

FIG. 3 shows a corner locating device attached to the rail;

FIG. 4 shows an extension support member attached to the rail for extending the locations at which the mounting holes may be located;

FIG. 5 shows the device when used for mounting multiple objects; and

FIG. 6 shows the device being used to mark successive locations, each the same distance apart on a vertical surface.

### BEST MODE FOR CARRYING OUT THE INVENTION

The following description is of the best presently contemplated mode of carrying out the present invention. This description is not to be taken in a limiting sense but is made merely for the purpose of describing the general principles of the invention. The scope of the invention should be determined by referencing the appended claims.

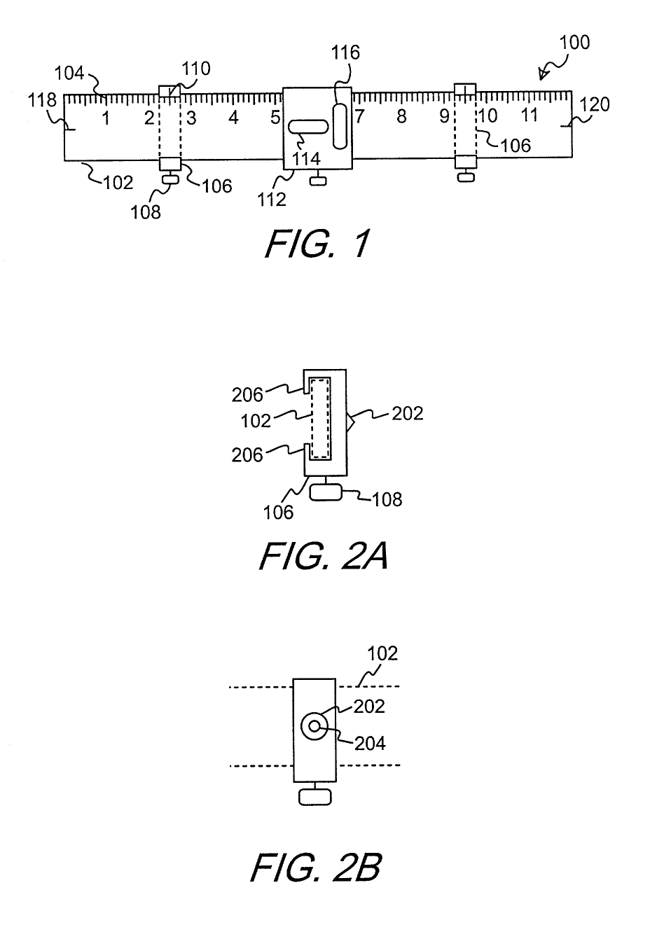

FIG. 1 shows a front view of the Precision Alignment and Marking Device of the present invention. Referring to FIG. 1, the Precision Alignment and Marking Device 100 contains a support member, or rail, 102 that has calibration markings 104 indicating regular calibrated intervals, such as inches, centimeters, etc. Two marking brackets 106 are movably attached to the rail 102 through the use of thumb screws 108 or similar locking devices. On the front of each marking bracket is an indicator 110 which is used to align with the calibration marks 104. The indicator 110 is also aligned with a marking element (not shown in FIG. 1) located on the back of each marking bracket 106, such as a center punch, which is used to create the mark on the wall. Marks 118 and 120, at respective ends of the rail 102 show the vertical location of the marking elements (not shown in FIG. 1) for ease in aligning the marking elements at precise vertical locations.

A leveling bracket 112 is also movably attached to the rail 102 using a thumb screw 118. A horizontal level 114 and a vertical level 116 are attached to the leveling bracket 112. The horizontal level 114 and the vertical level 116 are used to level the rail 102 which levels the device 100 and thus levels the locations of the marks that are made by the marking elements.

In operation, when an object is to be mounted on a wall it typically is mounted a fixed distance from a corner of the wall. For example, if the object is to be mounted with its center twelve inches from the corner, and mounted using two mounting holes spaced four inches apart, the left marking bracket 106 might be moved to a position ten inches from the corner, thus its indicator 110 would be placed at a calibration mark showing ten inches on the rail 102. The right marking bracket 106 would be moved to a location with its indicator at a calibration mark showing fourteen inches on the rail 102. The leveling bracket 112 could be placed anywhere along the rail, but would be typically placed at the point on the rail that achieves the most accuracy in leveling the rail 102. This accuracy is achieved by locating the level at a position where the level can easily be viewed from a location perpendicular to the level. After setting up the locations for the marking brackets and the leveling bracket, the rail would be placed against the wall at the desired vertical location. The rail would then be leveled using the horizontal level 114. The entire device is then pushed against the wall, so that the marking devices, located on the rear of the marking brackets 106, make indentations in the wall at the location where the hanging devices are to be located on the wall.

Thus, for example, when the device is grasped by placing one hand on each marking bracket, the device can easily be leveled and the indentations made by one person.

FIGS. 2A and 2B show detailed drawings of the marking bracket 106, wherein FIG. 2A shows a side view and FIG. 2B shows a rear view of the marking bracket 106. Referring now to FIGS. 2A and 2B, the marking bracket 106 is shown having the thumb screw 108 located at its bottom. On the rear of the marking bracket 106 is the marking element 202, which is typically a center punch having a point 204. The point 204 would typically extend only a very small distance since only a very slight mark is needed on the wall in order to provide the marking location. At the front of the marking bracket 106 is an overhang 206 which provides a u-shape at each end of the bracket to allow the marking bracket 106 to remain slidably attached to the rail 102 until the thumb screw 108 is screwed down on the bottom of the rail 102 to temporarily lock the marking bracket in place.

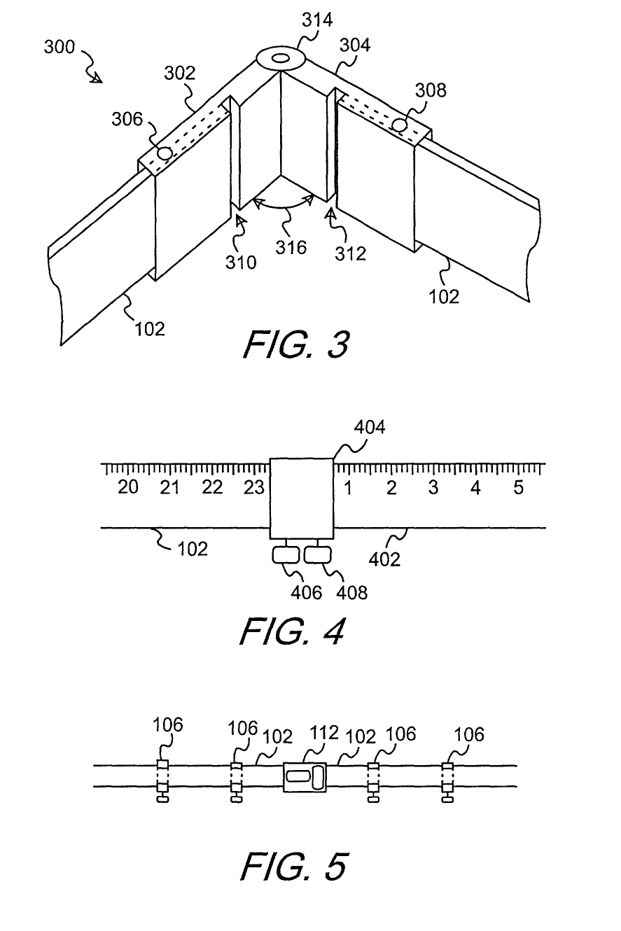

FIG. 3 shows a hinge bracket used to locate the device on an outside corner. Referring to FIG. 3, the hinge bracket 300 has a left hinged section 302 and a right hinged section 304. The left hinged section 302 and the right hinged section 304 are joined together by a center pin 314 which allows the hinged sections to be rotated through an angle, indicated by arrow 316, greater than 90 degrees. Each of the hinged sections contains a slot for inserting the rail 102 therein. The rail 102 is inserted into the hinged section 302, 304 until it is visible through a slot 310, 312. By inserting the rail 102 until it is visible in the slots 310, 312 the rail is placed at a precise fixed distance from a corner to the front edge of the rail 102.

In operation, the hinged element 302 and 304 are set to an angle 316 of approximately 90 degrees and held against an outside corner. This locates the rail 102 a precise distance from the outside corner, and allows the marking brackets to be fixed a precise distance from the corner.

FIG. 4 shows an extension bracket which is used to provide distances longer than the length of a single rail. Referring to FIG. 4, an extension bracket 404 is mounted to a rail 102 using a thumb screw 406. A second rail 402 is mounted to the extension bracket 404 using a second thumb screw 408. Using the extension bracket 404, the length of the rail can be extended indefinitely using multiple extension brackets and multiple rails.

FIG. 5 shows the use of the device to mount multiple objects. Referring to FIG. 5, two pairs of marking brackets are mounted to a rail 102 to locate two objects side by side at the same vertical location. The rail 102 is placed against a corner either on the left or right location, and then two pairs of marking brackets 106 are used to locate two objects horizontally spaced apart.

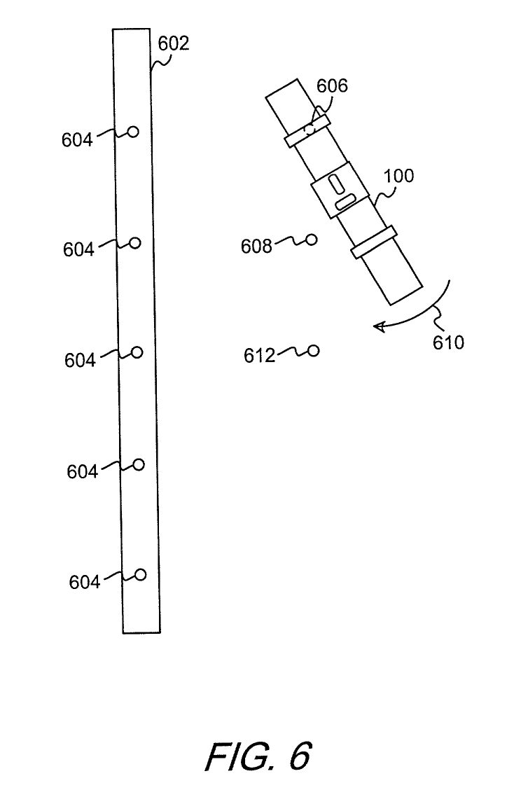

FIG. 6 shows the device being used to mark successive locations, each the same distance apart on a vertical surface. Referring to FIG. 6, a shelf mounting rail 602 is shown having a plurality of spaced apart mounting holes 604. The distance between each of the mounting holes 604 is the same, and typically this type of shelf mounting rail is mounted vertically on a wall wherein shelf mounting brackets are inserted into the rail at desired locations for shelves. Each location for one of the holes 604 can be easily marked by the device 100 by locating a first mounting hole location 606, marking it, and the by pivoting the device 100 about hole location 606 in the direction of arrow 610. This pivoting is aided by the indentation made by the marking element, wherein the marking element easily pivots within the indentation.

The device 100 is then aligned vertically using the vertical alignment level, and a second mounting hole 608 is marked. The device 100 is then pivoted about mounting hole 608, vertically aligned, and a third mounting hole 612 is marked. This continues until all the mounting holes needed to mount the rail 602 have been marked. In this manner, the holes 606, 608, 612, etc. will be spaced apart the correct distance, and they will be vertically aligned with each other.

Having thus described a presently preferred embodiment of the present invention, it will be understood by those skilled in the art that many changes in construction and widely differing embodiments and applications of the invention will suggest themselves without departing from the scope of the present invention as defined in the claims. The disclosures and the description herein are intended to be illustrative and are not in any sense limiting of the invention, defined in scope by the following claims.

What is claimed is:

1. A device for identifying and marking a location for mounting an object on a surface, said device comprising:
a rail having calibration marks thereon; and
a marking bracket slidably attached to said rail, said marking bracket comprising
a marking bracket frame having u-shaped cross sections at either end, wherein said u-shaped cross sections slidably attach said marking bracket frame to said rail,
an indicator mark on a front of said marking bracket frame, said indicator mark for aligning said marking bracket frame with one of said calibration marks, and
a marking element attached to a rear of said marking bracket frame, said marking element for marking said surface, and wherein said marking element is aligned to said indicator mark;
wherein after placing said rail adjacent said surface and aligning said indicator mark to a desired location for mounting said object, said device is pressed against said surface causing said marking element to mark said surface at said desired location.

2. The device of claim 1 wherein said marking element comprises a center punch.

3. The device of claim 1 further comprising a leveling bracket slidably attached to said rail, said leveling bracket comprising:
a leveling bracket frame having u-shaped cross sections at either end, wherein said u-shaped cross sections slidably attach said leveling bracket frame to said rail at a location on either said of said marking bracket; and
at least one level attached to said leveling bracket frame, said level for indicating that said device is level.

4. The device of claim 1 further comprising:
a locking device attached to said marking bracket frame, wherein said locking device temporarily locks said age marking bracket to said rail.

5. The device of claim 1 further comprising a second marking bracket comprising:
a a second marking bracket frame having u-shaped cross sections at either end, wherein said u-shaped cross sections slidably attach said a second marking bracket frame to said rail;
an indicator mark on a front of said a second marking bracket frame, said indicator mark for aligning said a second marking bracket frame with one of said calibration marks; and
a marking device attached to a rear of said a second marking bracket frame, said marking device for marking said surface, and wherein said marking device is aligned to said indicator mark.

6. The device of claim 1 further comprising:
a hinge bracket mounted to one end of said rail, said hinge bracket for aligning said rail to an outside corner of a surface.

7. The device of claim 1 further comprising:
a second rail having calibration marks thereon;
a connecting bracket attached to said rail and said second rail to connect said second rail to form an extension of said rail.

8. A method for identifying and marking locations for mounting an object on a surface, said method comprising the steps of:
(a) slidably locating at least one marking bracket at a marked location on a rail, said at least one marking bracket being located by aligning an indicator mark on said at least one marking bracket to a calibration mark on said rail, wherein said indicator mark further aligns with a marking element on an opposite side of said at least one marking bracket from a side of said least one marking bracket that contains said indicator mark;
(b) slidably locating a leveling bracket, having a level mounted therein, along said rail and adjusting a position of said rail;
(c) adjusting said rail until said level indicates that said rail is level;
(d) pressing said rail and said marking bracket into said surface to thereby mark said location for mounting said object.

9. The method of claim 8 wherein step (a) further comprises the step of:
(a1) abutting a first end of said rail to a corner of said surface thereby aligning said marking bracket a distance, determined by said calibration mark, from said corner.

10. The method of claim 8 wherein step (a) further comprises the step of:
(a1) abutting a first end of said rail to a hinge bracket; and
(a2) placing said hinge bracket around an outside corner of said surface wherein said marking bracket is aligned at a distance, determined by said calibration mark, from said outside corner.

11. The method of claim 8 further comprising the steps of:
(e) slidably locating a second marking bracket on said rail;
(f) aligning said second bracket to mark a second location, and pressing said rail and said second marking bracket into said surface to thereby mark said second location;
(g) pivoting said rail about said location marked in step (f) until said at least one marking bracket is aligned at a point on an opposite side of said second location; and
(h) pressing said rail and said at least one marking bracket into said surface to thereby mark a third location with said at least one marking bracket, wherein said third location is in a same line as said locations marked in steps (d) and (f).

12. A device for identifying and marking a plurality of locations for mounting an object on a surface, said device comprising:
a rail having calibration marks thereon;
a pair of marking brackets slidably attached to said rail, each marking bracket comprising
a marking bracket frame having u-shaped cross sections at either end, wherein said u-shaped cross sections slidably attach said marking bracket frame to said rail,
an indicator mark on a front of said marking bracket frame, said indicator mark for aligning said marking bracket frame with one of said calibration marks, and
a marking element attached to a rear of said marking bracket frame, said marking element for marking said surface, and wherein said marking element is aligned to said indicator mark; and
a leveling bracket slidably attached to said rail, said leveling bracket comprising
a leveling bracket frame having u-shaped cross sections at either end, wherein said u-shaped cross sections slidably attach said leveling bracket frame to said rail at a location on either said of said marking bracket, and
at least one level attached to said leveling bracket frame, said level for indicating that said device is level;
wherein after placing said rail adjacent said surface and aligning said indicator mark of each marking bracket to one of said plurality of locations for mounting said object, said device is pressed against said surface causing said marking element of each marking bracket to mark said surface at one of said locations.

13. The device of claim 12 wherein said marking element of each marking bracket comprises a center punch.

14. The device of claim 12 further comprising:
a locking device attached to said frame of each marking bracket, wherein said locking device temporarily locks said marking bracket to said rail.

15. The device of claim 12 further comprising:
a hinge bracket mounted to one end of said rail, said hinge bracket for aligning said rail to an outside corner of a surface.

16. The device of claim 12 further comprising:
a second rail having calibration marks thereon;
a connecting bracket attached to said rail and said second rail to connect said second rail to form an extension of said rail.
